(19) United States
(12) Patent Application Publication
(10) Pub. No.: US 2025/0358114 A1
(43) Pub. Date: Nov. 20, 2025

(54) SYSTEM AND METHOD FOR SECURING THE AUTHENTICATION OF CONNECTIONS TO WEB SERVICES OVER PUBLIC NETWORKS

(71) Applicant: Haim VITAL, Raanana (IL)

(72) Inventor: Haim VITAL, Raanana (IL)

(21) Appl. No.: 18/665,621

(22) Filed: May 16, 2024

(51) Int. Cl. H04L 9/32; H04L 9/08

(52) U.S. Cl. CPC H04L 9/321; H04L 9/085

(57) ABSTRACT

The subject matter discloses system and method for securing the authentication of connections to web services over public networks with HMAC messages that utilizing shared key that is shared via mail.

### FIELD OF THE INVENTION

The present disclosure relates to networking in general, and to web services authentication while using public networks, in particular.

### BACKGROUND OF THE INVENTION

A spoofing attack is whereas attacker fakes an identity to steal credentials, E.g. an ARP spoofing, also known as ARP poisoning, is a Man in the Middle (MitM) attack that allows attackers to intercept communication between network devices. The attack works as follows: The attacker scans the network to determine the IP addresses of two devices: a workstation and a router. The attacker uses a spoofing tool to advertise that the correct MAC address for the IP of the router is the attacker's MAC address. Such spoofing fools the workstation to connect to the attacker's machine, instead of the router to communicate with the attacker instead of directly with the router. In spoofing attacks, the attacker fakes a website along with website's SSL certificate and steals provided credentials such as username hash, password and One Time Passcode (OTP). From that point the user's account is vulnerable to attacker's actions.

The JWT tokens are used to create stateless HTTP protocol that stores the session state inside the session by using the JWT token. The JWT token is signed by the server and sent to the client while carrying the HTTP state securely inside the token, while being transmitted via SSL (TLS/HTTPS) encrypted channel and sent back by the client as is, relying on the secure SSL (TLS/HTTPS) channel to save the expensive costs of storing the session state on the server's side memory; making the storage of the session state being stored outside the server and rather on the client's side.

### SUMMARY OF THE INVENTION

The term computing device refers herein to a device that includes a processing unit. Examples for such device are a personal computer, a laptop, a server, a wearable device, a tablet a cellular device and IoT (internet of things) device or sharable processing power such as cloud and virtual instances that share the same CPU, memory, network with isolation etc.

The term web service refers herein to a service over the web. Examples of such a service are services via web site or via an application.

The term authentication service refers herein to a service for securing the authentication of connections to web services over public networks.

The term message-signature refers herein to a value that is generated by encrypting the data of a message that is transferred between the sender and the receiver during a communication session. The encryption is performed by methods such as HMAC functions. The message-signature is used for validating the data of the message that is sent between the parties of the communication session and for authenticating the sender of the message.

The term signed data object refers herein to a software object that is sent in a communication session. The software object includes unencrypted data and a message signature. In some embodiment the software object is a JSON web token (JWT).

The term URI (unified resource identifier) fragment refers herein to the part in the URI which follows the hash symbol “#”. The URI fragment is not sent by the browser to the server in accordance with the HTTP protocol. The URI fragment includes the shared key.

Embodiments of the invention disclose system and method for securing the authentication of connections to web services over public networks. According to some embodiments the communication between the web service and the client is secured by a shared key which is sent to the client via a dedicated network channel. The dedicated network channel is a network channel that is different from the network channel that is used for the communication session. An example for such a network channel is email.

According to some embodiments the shared key is stored in the browser's local storage. The shared key is used for creating the message-signature. The message signature is for validating the data of the signed data object and the sender of the signed object.

According to some embodiments, a second shared key is sent to the web service to allow the web service to request the authentication service to sign the responses of the web service to the requests of the client. According to some embodiments the second shared key is sent via email to the web service owner for securing the communication with the authentication service.

According to some embodiments the access to the shared key is via a static web page of the authentication service. The static web page includes functions for storing the shared key in the local storage of the client and for utilizing the shared key for validating and signing the signed data object.

One technical problem dealt with by the present disclosure is how to authenticate the communication sessions over the internet. Such communication is vulnerable to attacks such as ARP spoofing, DNS spoofing, SSL Stealing, Session ID Hijacking and redirecting the user to a malformed website for the collection of user's credentials. In one example the DNS is spoofed and the hijacked website service might have a valid SSL certificate whilst the SSL is stripped behind the scenes and the traffic is visible to the attacker along with the credentials, JWT tokens and Session IDs.

One other technical problem is how to secure the stateless HTTP or HTTPS protocol that is implemented with JWT Tokens or Session IDs. The JWT token ensures stateless sessions but does not validate the client's identity nor the server's identity. The Session IDs authentication relies on SSL solely making it vulnerable for phishing attacks based on spoofing. Fake website with legitimate SSL certificate may steal the session ID via the DNS spoofing attack.

One technical solution is:

At the sender side: generating the message-signature and signing the data with the shared key. At the receiver side:
Validating the signed data object by generating a validating message-signature and by comparing the message-signature of the signed data object with the validating message signature. The generating of the validated message-signature includes the encrypting the data of the received message with the shared key. The message is authenticated only if the signatures are equal.
Generating an acknowledgement signed data object. The acknowledgment signed data object includes an acknowledgment field, the data of the original message and a message signature. The acknowledgment field is true if the message is validated and false if the message is not validated. The generation of the message-signature includes the encrypting of the data of a message and the acknowledgement field with the shared key.
Sending the acknowledgement signed data object to the sender.

At the receiver side:
Validating the acknowledgement signed data object.
Continuing the session if the acknowledgement signed data object is validated and if the acknowledgment field indicates that the receiver validated the message.
Terminating the session or retrying again if the acknowledgement signed data object is no validated or if the acknowledgment field indicates that the receiver did not validate the message.

The shared key between the computing devices is shared via a designated network channel such as email. Such designated network channel differs from the network channel that is used for the communication session.

One other technical problem is how to keep safe the shared key on the side of the client's browser without exposing it to malicious scripts intended to transmit it to malicious web services or the attackers themselves.

One technical solution is to secure the shared key by separating the static web page into two separated portions. The first portion includes the functions for storing the shared key and for generating and signing the signed data object with the shared key. The second portion is a wrapper that used for calling the functions of the first portion, such that only the functions of the first portions access the shared key. The web service utilize the wrapper functions for operating the function of the first portion.

The shared key is secured due to the following:

The web server and the client operate only the functions of the wrapper.

The functions of the wrapper are immutable functions that cannot be altered or changed by the code injection nor run an injected code in the context of their domain which is the static website wrapper domain.

Since a website lacks the capability to directly execute code within another website unless it is a code injection via a request, the prevention of the code injection to the wrapper of the static web page is achieved by:
Utilizing constant function definitions in which there is no option for assignment new or foreign function.
Eliminating usage of functions that can manipulate DOM (Document Object Model). An example of such a function is document.write.
Validating that the input to the static web page wrapper does not include the vulnerable special characters: single quotation mark, double quotation mark and backslash. One validation method is to filter those vulnerable characters with a filter that doubles each one of them if found in the script during input and reduces each pair of them by 2 during usage, i.e. when displaying user output.
   Those three measures of security secure the wrapper from being vulnerable to code injection, hence securing the shared key from the website service, an attacker and possible attacks on the website.

The allow origin enables only the authentication service access the first portion of the static web page and, thus, to operate the functions that access the shared key.

One other technical problem is how to edit response data on the side of the website service.

### One Technical Solution is:

Sharing a second encryption key between the website service and the authentication service for securing the communication between the website service and the authentication service. Such communication is for modifying the response data object and re-signing it using the second shared key.

One other technical problem is how to secure the shared key during transmission over the network. Typically, the shared key is sent via SSL and is exposed to man in the middle.

One technical solution is sending the shared key via communication channel separated from the communication channel of the session, such as email.

One other technical solution is storing the shared key in the browser's local storage via a web link with a browser URI fragment. The browser's URI fragment is the part after the # in the URL and is not being sent anywhere by the browser, whilst a locally running JavaScript in the static web page is able to access it. The link is sent in the email and when the user clicks it, the link opens the authentication service page with locally run JavaScript which stores the browser's URI fragment in the browser's local storage.

In some aspects of the present invention relates to a non-transitory computer-readable medium comprising instructions which when executed by at least one processor causes the processor to perform the method of the present invention.

One exemplary embodiment of the disclosed subject matter is a computer-implemented method, comprising: at a client computing device: starting a communication session between the client computing device and a server of a web service; receiving a shared key from an authenticating service via a designated channel; generating a signed data object; the signed data object comprising data and a message-signature; the message-signature being generated by encrypting the data with the shared key; transmitting the signed data object to the server of the web service and from the server of the web service to the authentication service; or transmitting the signed data object to the authentication service; at the authentication service: receiving the signed data object; validating the signed data object with the shared key; if the signed data object being validated then: generating a validated signed data object; wherein data of the validated signed data object comprises the data, an authentication filed indicating a success of the validating; transmitting the validated signed data object to the server of the web service and form the server of the web service to the client computing device; or transmitting the validated signed data object to the client computing device; if the signed data object not being validated then: generating a rejected signed data object; the data of the rejected signed data object comprises the data, an authentication filed indicating a failure of the validating and a second message-signature; the second message-signature being generated by encrypting the data and the authentication filed with the shared key; transmitting the rejected signed data object to the server of the web service and further, at the server of the web service, transmitting the signed data object to the client computing device; or transmitting the signed data object to the client computing device; and at the client computing device: If receiving a validated sign data object, then: validating the validated signed data object and continuing the session data if the validated signed data object being validated; otherwise terminating the session or initiating a retrying of the session; or if receiving a rejected signed data object terminating the session or initiating a retrying of the session. 2. The method of claim 1 wherein the data of the signed data object comprises an action. The method of claim 2 further comprising: if the signed data object being validated then at the server of the web service performing the action. The method further compromising: at the server of the web service in response to receiving the validated signed data object, generating a response signed data object; the data of the response data object comprises the validated signed data object and additional-data or an instruction for amending the data of the validated signed data object; signing the response signed data object with a second shared key; the second shared key being shared between the web service server and the authentication server; transmitting the response signed data object to the authentication service server and at the authentication service server generation an amended signed data object from the response signed data object and sending the amended signed data object to the client computing device. According to some embodiments the amended signed data object comprises the data of the validated signed data object and additional-data or an amendment of the data of the signed data object in accordance with the instruction. According to some embodiments the designated channel being a mailbox. According to some embodiments the additional data comprises big data, the response signed data object comprises a the signed data object and a checksum of the big data, the message signature of the response data object being generated by encrypting the signed data object and the checksum; wherein the amended signed data object comprises the signed data object and the checksum of the big data; the message signature of the response data object being generated by encrypting the signed data object and the checksum. One exemplary embodiment of the disclosed subject matter is a system, the system comprises: a web site service.com 1021 being installed on an authentication server; the web site service.com 1021 comprises a validation function 10211, a string generation function 10213, a key generation function 10212, a communication unit 10214, a static web page 1025 and a function for generating a signed data object 10218; the key generation function 10212 is configured for generating a shared key; the static web page 10215 includes a function for storing the shared key in the in a client browser's persistent cache; the function for generating a signed data object 10218 is configured for generating a Message-signature with the shared key and for signing a data object with the Message-signature; the validation function 10211 is configured for validating the signed data object with the shared key; the string generation function 10213 is configured for generating a string, the string comprises a URL (Uniform Resource Locator) to the static web page 1025 and a shared key; the string being sent to a client computing device via the communication unit; the communication unit 10214 is configured for transmitting the signed data object to the web site service.com 1021 for being sent to the client computing device; and for transmitting via email the shared key to the client computing device; a client authentication module, the client authentication module comprises the validation function 10211, a client communication unit 10314, the function for generating a signed data object 10218; the client communication unit 10314 is configured for transmitting the signed data object to the web service for performing an action and for being sent to the authentication service; the client authentication module is further configured for receiving the shared key 10216 from the mailbox from the client. According to some embodiments the web site service.com further comprising an allow origin function 10217. The static web page is separated into two portions; wherein a first portion of the static web page includes a function for accessing the shared key and wherein a second portion of the static web page includes a wrapper function the wrapper function is configured for activating the function for accessing the shared key, wherein the wrapper function is further configured for being used by the client authentication module and by a web server of the web site service.com. The method of claim 7, wherein the function being a validation function 10211. According to some embodiments the function being a string generation function 10213. According to some embodiments the function being the function for generating a signed data object.

Embodiments of the invention may be implemented as a computer process (method), a computing system, or as an article of manufacture, such as a computer program product or a non-transitory computer-readable media. The computer program product may be a computer storage media readable by a computer system and encoding a computer program of instructions for executing a computer process on the computer and network devices. The computer program product may also be a propagated signal on a carrier readable by a computing system and encoding a computer program of instructions for executing a computer process.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a block diagram of an environment for authenticating connections to a web service over public networks, in accordance with some exemplary embodiments of the subject matter;

FIG. 2 shows a block diagram of a method for authenticating connections to a web service over public networks, in accordance with some exemplary embodiments of the subject matter;

FIG. 3A shows an example of a string that is sent to the client of an application, in accordance with some exemplary embodiments of the disclosed subject matter;

FIG. 3B shows an example of strings that is sent to the client of a web site, in accordance with some exemplary embodiments of the disclosed subject matter;

FIG. 4a shows an exemplary block diagram of a signed data object, in accordance with some exemplary embodiments of the disclosed subject matter;

FIG. 4b shows an exemplary block diagram of a validated signed data object, in accordance with some exemplary embodiments of the disclosed subject matter;

FIG. 5 shows a block diagram of the web site service.com, in accordance with some exemplary embodiments of the disclosed subject matter;

FIG. 6 shows a block diagram of the client authentication module, in accordance with some exemplary embodiments of the disclosed subject matter;

FIG. 7 shows a flowchart diagram of the user login process, in accordance with some exemplary embodiments of the disclosed subject matter;

FIG. 8 shows a flowchart diagram of the scenario of adding a response to the request of the user, in accordance with some exemplary embodiments of the disclosed subject matter;

FIG. 9A shows an exemplary block diagram of a first embodiment of a response signed data object, in accordance with some exemplary embodiments of the disclosed subject matter;

FIG. 9B shows an exemplary block diagram of a first embodiment of an amended signed data object, in accordance with some exemplary embodiments of the disclosed subject matter;

FIG. 10A shows an exemplary block diagram of a second embodiment of a response signed data object, in accordance with some exemplary embodiments of the disclosed subject matter;

FIG. 10B shows an exemplary block diagram of a second embodiment of an amended signed data object, in accordance with some exemplary embodiments of the disclosed subject matter;

FIG. 11 shows a flowchart diagram of the scenario of adding a response with big data to the request of the user, in accordance with some exemplary embodiments of the disclosed subject matter;

FIGS. 12A and 12B show an exemplary block diagram of a response signed data object with big data, in accordance with some exemplary embodiments of the disclosed subject matter; and

FIG. 13 shows an exemplary block diagram of an exemplary static web page in accordance with some exemplary embodiments of the disclosed subject matter.

### DETAILED DESCRIPTION

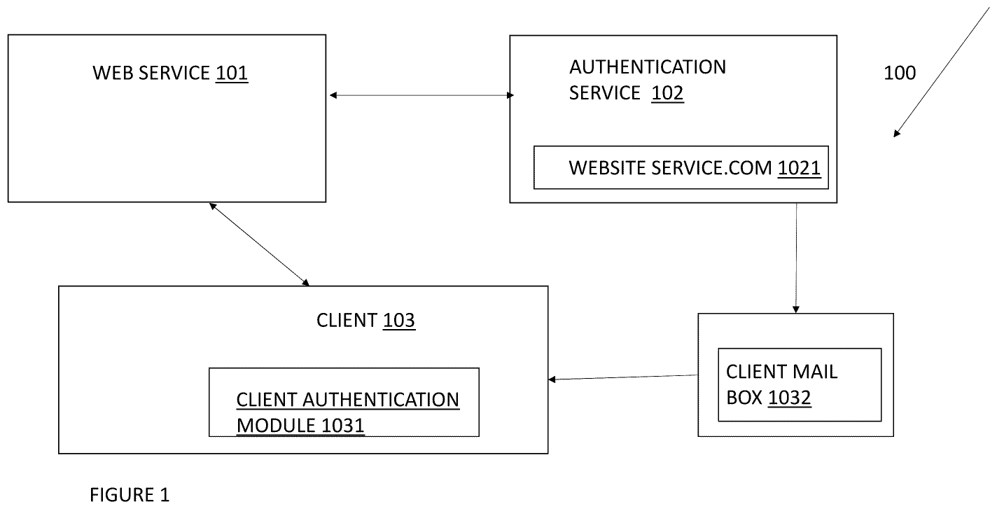

FIG. 1 shows a block diagram of an environment for authenticating connections to a web service over public networks, in accordance with some exemplary embodiments of the subject matter.

Environment 100 includes a web service 101, an authentication service 102 and client computing device 103.

The web service 101 includes a service over the web which can be implemented, for example, via web site or via an application.

The web service 101 operates on one or more servers. The web service is configured for providing internet services to the user. The web service 101 communicates with the authentication service 102 for authenticating the service. The web service 101 communicates with the client 103 for providing a service to the client.

The authentication service 102 is configured for securing the authentication of connections to web services over public networks. The authentication service 102 may be provided by one or more proprietary servers or may reside on virtual resource such as a computing cloud.

The authentication service 102 communicates with the web service 101.

In some embodiments the authentication service 102 generates website service.com 1021 per each web service that utilizes the authentication service 102.

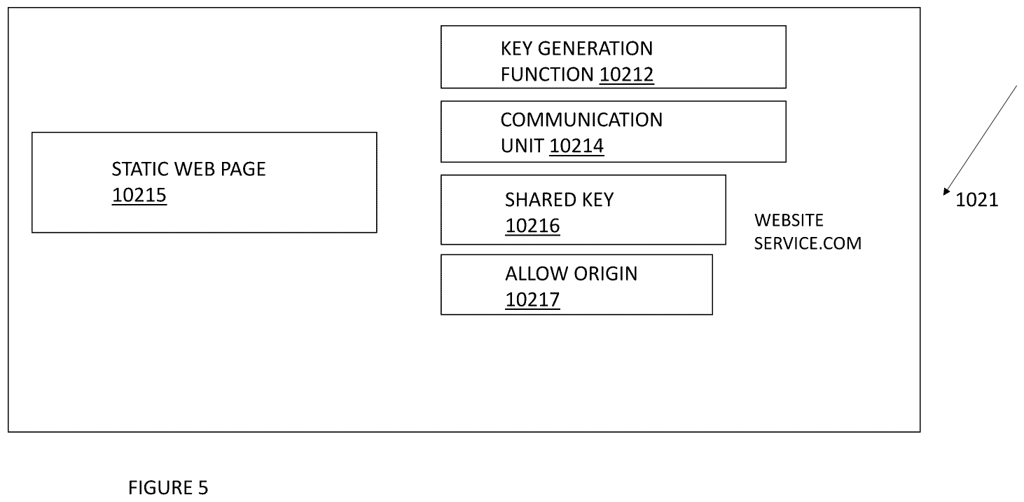

The website service.com 1021 provides the authentication for the web service. For example, the authentication service 102 generates amazon service.com for the site amazon.com. Amazon service.com authenticates the session between amazon.com and the clients of amazon. The website service.com 1021 is described in greater details in FIG. 5.

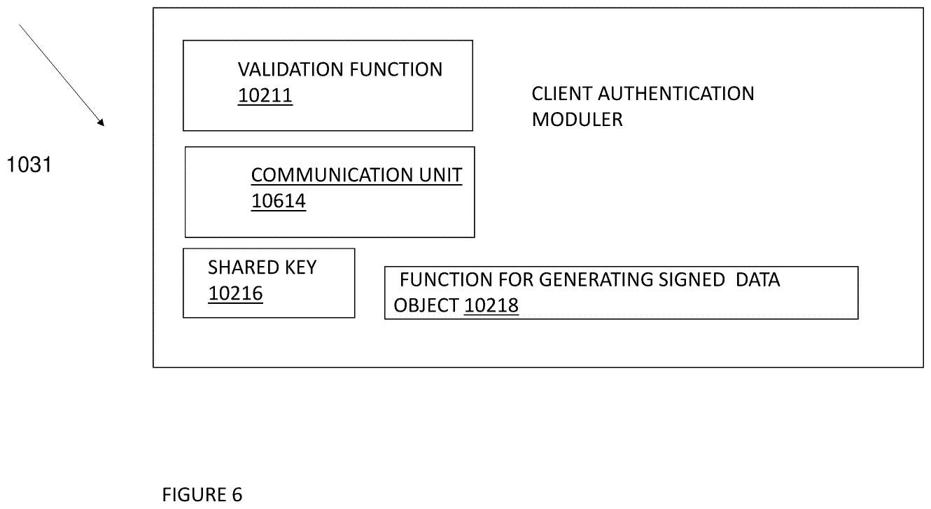

The client computing device 103 is configured for communicating with the web service 101 for receiving web services and for authenticating the communication between the client 103 and the web service 101. Each client includes client authentication module 1031. The client authentication module 1031 is described in greater details in FIG. 6.

The client computing device 103 receives the shared key via the client mailbox 1032.

The shared key is for authenticating the communication between the client and the web service. The shared key is shared between the client 103 and the authentication service 102 via email for authenticating the messages between the client 103 and the web service 101. The messages from client 103 to the web service 101 are authenticated by the authentication service 102 are forwarded from the web service 101 to authentication service 102.

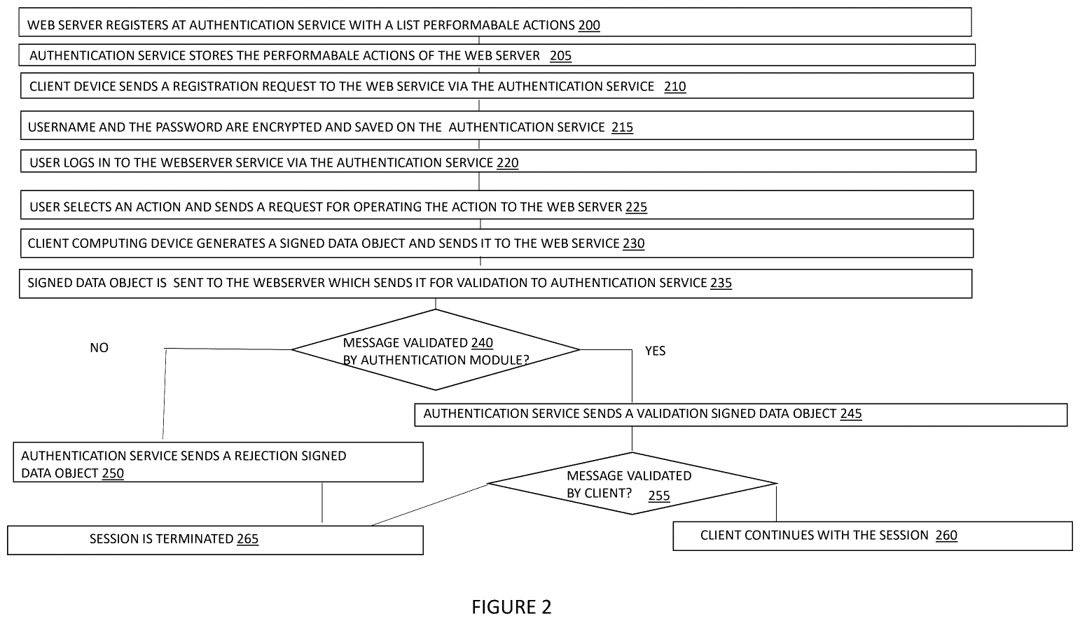

FIG. 2 shows a block diagram of a method for authenticating connections between a webserver and a client, in accordance with some exemplary embodiments of the disclosed subject matter.

Blocks 200 and 205 describe the registration of a webserver to the authenticating service. During the registration process the webserver transfers the list performable actions to the authenticating service. The performable actions are used to be sent from the client while interacting with the webserver. Examples of such performable actions are add to chart, remove from chart, purchase, select an item etc.

At block 200 the webserver sends a registration request to the authentication service. The registration request includes parameters such as an identification of the website and the performable actions.

At block 205 the authentication service receives the registration request and stores the registration parameters of the request along with the list of performable actions. The username and the password are encrypted and stored in the server of the service according to standards such a BCRYPT with 12 rounds as per RFC to the date. The authentication server then sends a shared key to the webserver. The shared key is for the communication between the authentication service and the webserver.

Blocks 210 and 215 describe the registration of the user to the web service from a web browser.

At block 210 the client device sends a registration request to the web service. The webserver sends the registration request to the authenticating service. The registration parameters include encrypted username and password.

At block 215 the username and the password are encrypted and saved on the authentication service according to standards such a BCRYPT with 12 rounds as per RFC to the date.

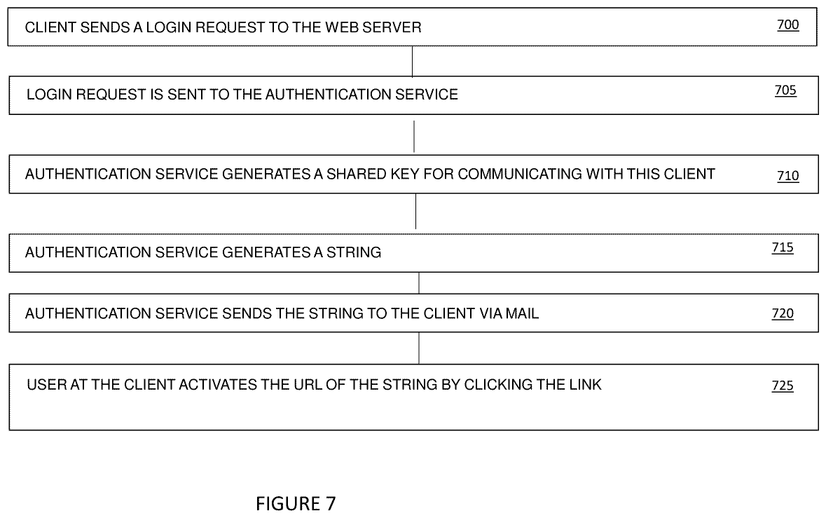

At block 220 the user logs in to the service from a web browser. During the log in process the client receives a shared key via email. The log in process is described in greater details in FIG. 7.

Blocks 225, 230, 235, 240, 245, 250, 255, 260, and 265 describe the communication between the client, the webserver and the authentication service for performing an authenticated action on the webserver by the client.

At block 225 the user selects a performable action and sends the request with the performable action to the webserver. In one example the request is “insert to chart”.

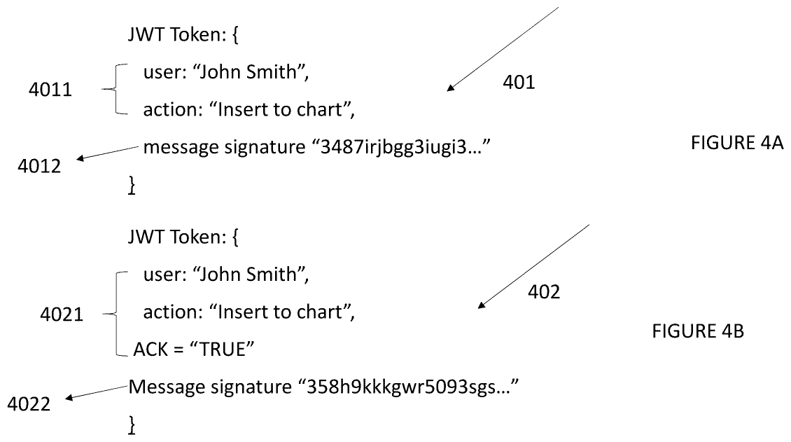

At block 230 the client computing device generates a signed data object. The signed data object includes the data to be sent. The data to be sent includes the identification of the user and the identification of the request. The signed data object is signed by the message-signature. The Message-signature is generated by encrypting the data to be sent with the shared key. An example of such signed data object is described in FIG. 4A.

At block 235, the client computing device sends the signed data object to the web service which sends it to the authentication service for validation.

At block 240, the authentication service validates the message. The validation is by regenerating the message-signature and by comparing the regenerated message-signature with the Message-signature of the received signed data object. If the two message-signatures are equal, the message is validated. The regenerating of the Message-signature is by encrypting the data of the message with the shared key that is stored at the authentication service.

At block 245 which occurs if the message is validated, the authentication service generates a validated signed data object. The data of the validated signed data object includes fields of the data object such as user identifier and a performable action; and an authentication field indicating that the message is validated (e.g. by the value “TRUE”). An example of such validation signed data object is described in FIG. 4B. The authentication service sends the message to the web service server.

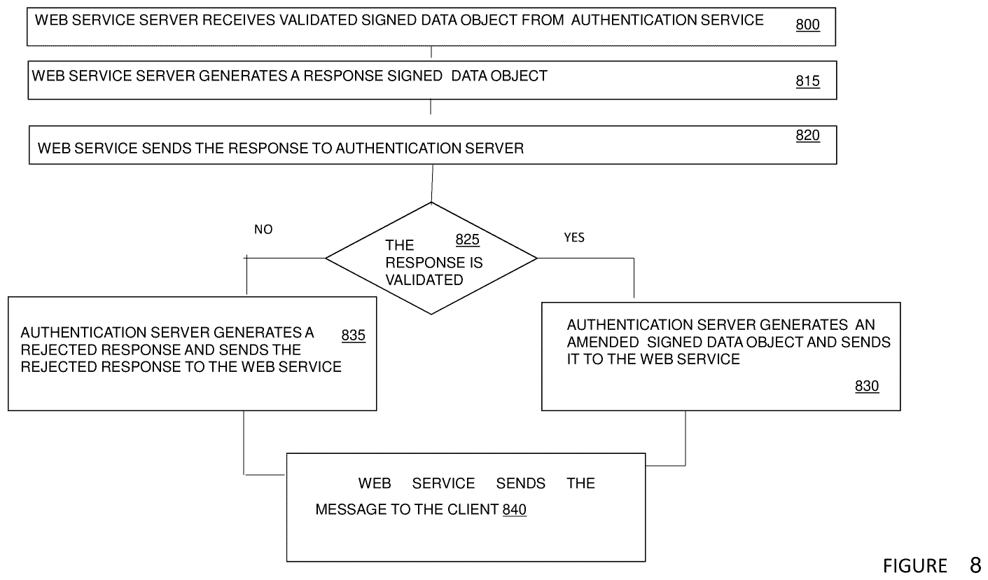

The web service server performs the action and sends the validated message to the client. In some cases, the web service server adds data to the validated message; for example, the web service server may add an invoice to a purchase request. Such a case is explained in greater details in FIG. 8.

At block 250 which occurs if the message is not validated, the authentication service generates a rejected signed data object. The data of the rejected signed data object includes an identification of the user, the identification of the action and a rejection field. (e.g. “FALSE”). The authentication service sends the rejected sighed data object to the server of the web service which sends the message to the client.

Blocks 255 and 260 and 265 occur if the client receives a validated signed data object.

At block 255 the client validates the message. The validation is by regeneration a message-signature from the data of the message and by comparing the regenerated Message-signature with Message-signature of the received message. If the message is not validated the operation continues to block 265.

At block 260 which occurs if the validated signed data object is validated, the client continues with the session.

It should be noted that all the messages of the sessions are validated as explained in blocks 225, 230, 235, 240, 245, 250, 255, 260 and 265.

At block 265 which occurs if the received message not validated by the client or if the client receives a rejection message, the message is discarded, and the session is terminated or a retry is initiated.

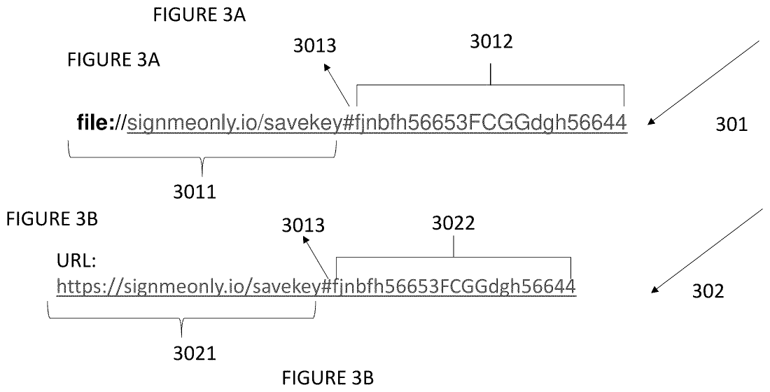

FIG. 3A shows examples of a string that is sent to the client of an application, in accordance with some exemplary embodiments of the disclosed subject matter. In such a case the communication from the client comes from an application E.g. in a mobile device and not a web browser. String 301 includes URL (Uniform Resource Locator) 3011 to an application, a hash tag 3013 and a shared key 3012. The link 3011 is to a static web page of the authentication service. The hash tag 3013 follows the link 3011, the shared key 3012 follows the hash tag 3013 in a URI Fragment. The method in the case of an application is as in the case of browse and is differed in the string.

FIG. 3B shows an example of a string that is sent to the client of a site, in accordance with some exemplary embodiments of the disclosed subject matter. String 302 includes second URL (Uniform Resource Locator) 3021 to a site, a hash tag 3013 and a shared key 3022. The link 3021 is to a static web page of the authentication service. The hash symbol 3023 follows the link 3021, the shared key 3022 follows the hash tag 3023.

FIG. 4A shows an exemplary block diagram of the signed data object, in accordance with some exemplary embodiments of the disclosed subject matter.

Signed data object 401 includes data part 4011 and Message-signature 4012.

Signed data object 401 is used for transferring a request for action from the client to the webserver.

FIG. 4B shows an exemplary block diagram of a validated signed data object, in accordance with some exemplary embodiments of the disclosed subject matter.

Validated signed data object 402 includes data part 4021 and message-signature 4022.

Validated signed data object 402 is used for transferring an acknowledgment from webserver to the client. The data of the signed data object 4021 includes user field, action fiend and an acknowledgment field. In the figure the acknowledgment filed includes the value “TRUE” which means that the data is validated. The action field includes the action that the user requests to perform.

FIG. 5 shows a block diagram of the service website service.com, in accordance with some exemplary embodiments of the disclosed subject matter.

According to some embodiment website service.com is generated by the authentication service per each web service and is configured for authenticating the messages between the web service and the clients of the web service.

Web service website service.com 1021 includes key generation function 10212, a communication unit 10214, a static web page 10215a shared key 10216 and an allow origin function 10217.

The key generation function 10212 for generating a shared key to be used between the client and the authentication service and between the client and the web service.

The communication unit 10214 is configured for transmitting the signed data object between the authentication service and the web service.

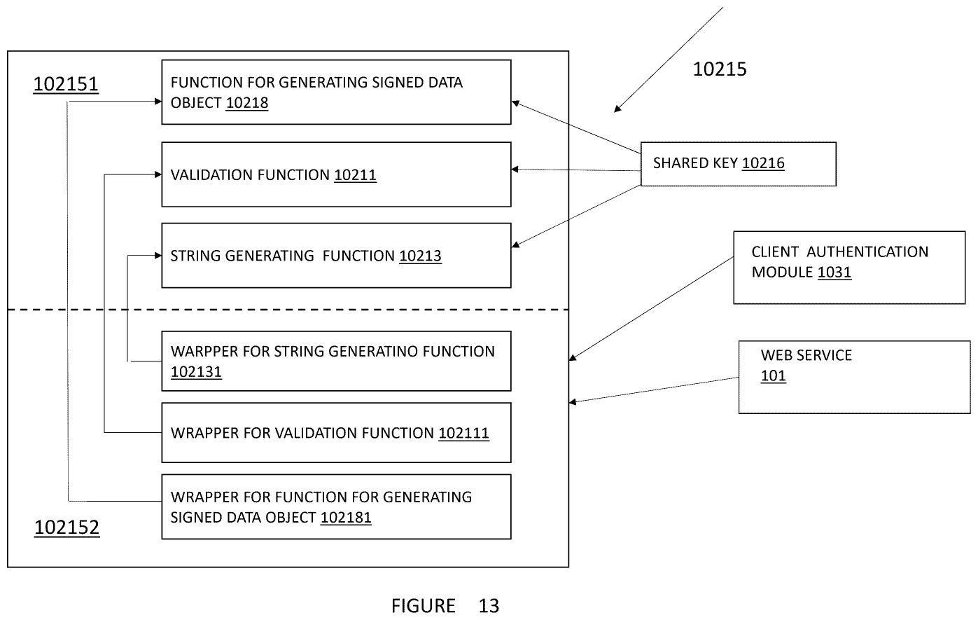

The static web page includes functions for storing the shared key in the local storage of the client and for utilizing the shared key for signing the signed data object. In some embodiments the functions are JavaScript functions. The static web page 10215 is explained in greater details in FIG. 13.

The shared key 10216 is configured for signing and validating the data of the signed data object.

The allow origin function 10217 is configured to allow only website.com to run a script on website service.com.

FIG. 6 shows a block diagram of the client authentication module, in accordance with some exemplary embodiments of the disclosed subject matter. The client authentication module 1031 is a part of the static webpage. The client authentication module includes a validation function 10211, a communication unit 10614, a function for generating a signed data object 10218 and a shared key 10216.

The validation function 10211 is configured for validating the signed data object. The validating is by generating a message-signature and by comparing the generated message-signature with the message-signature of the signed data object.

The communication unit 10614 is configured for transmitting the signed data object between the web service and the client and for receiving the shared key 10216 from the mailbox of the client.

The shared key 10216 is configured for encrypting the data of the signed data object. The encrypting is for signing the signed data object and for validating the signed data object.

The function for generating a signed data object 10218 is configured for generating a Message-signature and for generating the signed data object.

FIG. 7 shows a block diagram of the user login process, in accordance with some exemplary embodiments of the disclosed subject matter.

At block 700 the client sends a login request to the webserver.

At block 705 the login request is sent to the authentication service.

At block 710 the authentication service generates a shared key for communicating with this client. The shared key may be a random string. The shared key may include English letters and decimal numbers which are generated by a random function such as that in the standard random libraries of the supported programming languages.

At block 715 the authentication service generates a string. The string includes a URL (Uniform Resource Locator) to a static web page of the authentication service followed by a URI fragment-hash symbol “#” which is followed by the shared key. Example of such strings are depicted in FIGS. 3A and 3B.

At block 720 the authentication service sends the string to the client via mail.

At block 725 the user at the client activates the URL of the string by clicking the link. The URL opens a static webpage which is downloaded to the web browser and operates a local JavaScript function. In some embodiments the URL opens an app link such as in mobile devices and the app stores the shared key in the app's storage; Otherwise, the JavaScript function saves the shared key and the wrapper functions in the in the browser's local storage.

FIG. 8 shows a block diagram of the scenario of adding a response to the request of the user, in accordance with some exemplary embodiments of the disclosed subject matter. In some cases, the web service server responses to the authenticated client request. In such a case the web service server generates a response signed data object which includes the verified signed data object and the data of the response. The response signed data object is signed by a shared key that is shared between the web service server and the authentication service server. The authentication service server authenticates the response signed data object and generates a signed data object that includes the data of the response and is signed by the shared key that is shared between the authentication service server and the client. The authentication service server sends the response to the web service server and the web service server sends the response to the client.

### Referring Here to the Drawing:

At block 800, the web service server receives the validated signed data object from the authentication service as explained in block 245 of FIG. 2.

At block 815, the web service server generates a response signed data object.

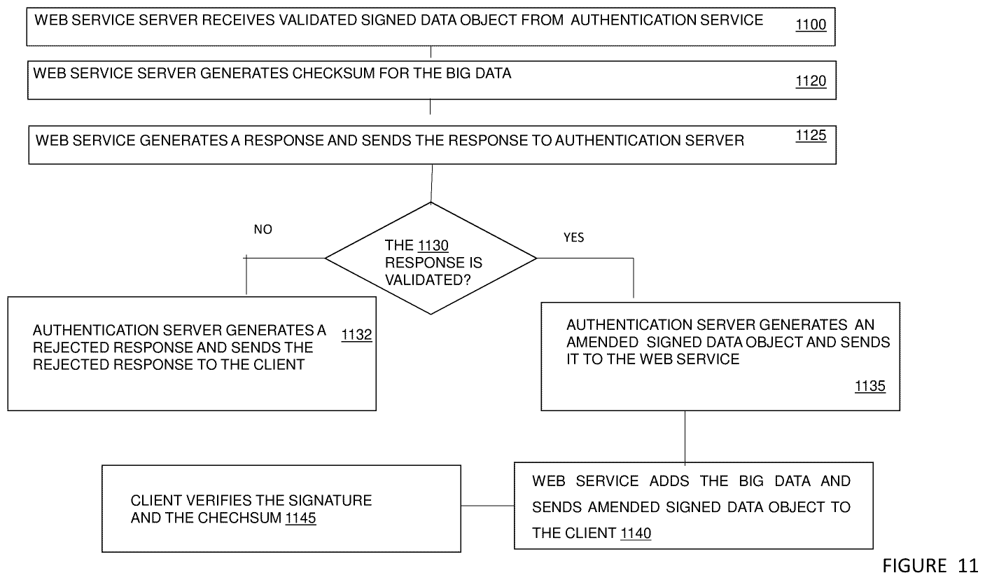

In some cases, the response includes additional data. In such cases the data of the response includes the validated signed data object and the additional data. The additional data may be, for example, in the form of a text, a file. In some cases, the additional data includes a big file such a case is described in FIG. 11. The web service server signs the response with a shared key that is shared between the web service server and the authentication service server.

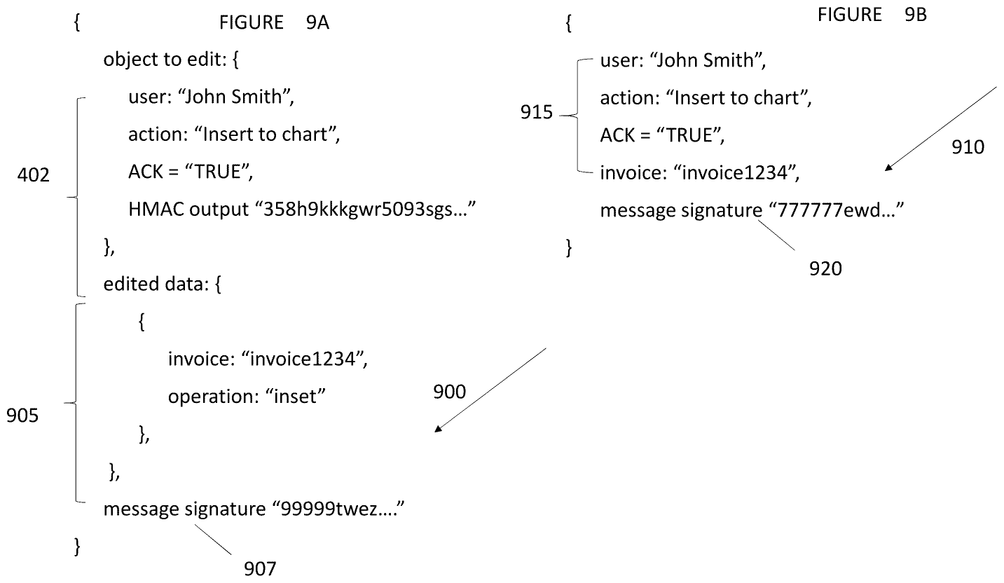

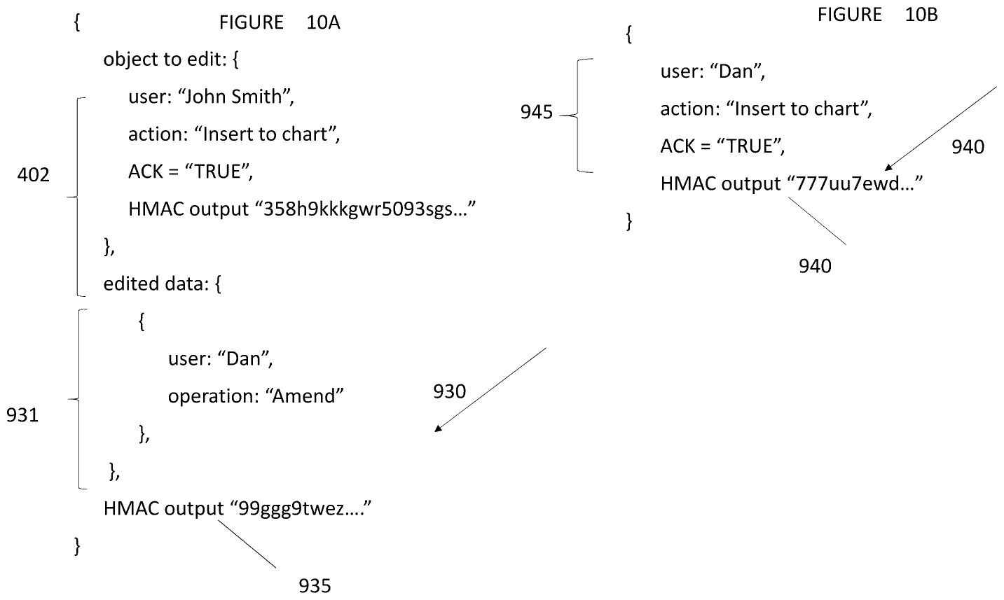

In some other cases, the data of the response signed data object includes a value of a field in the signed data object to be changed. Examples of the response signed data object is depicted in FIGS. 9a and 10a.

At block 820 the web service server sends the response to the authentication service.

At block 825 the authentication service authenticates the response signed data object. The authentication is performed with the shared key that is shared between the web service server and the authentication service server.

At block 830 which occurs is the response signed data object is authenticated the authentication service generates an amended signed data object. The data of the amended signed data object includes the data of the received signed data object and the additional data of the response. In some other cases, the data of the amended signed data object includes an amendment of a field in the signed data object as instructed by the response message.

The amended signed data object is signed with the shared key that is shared between the client and the authentication server. The authentication server sends the amended signed data object to the web service server to be sent to the client.

Note that in some cases the authentication service and the web service reside on the same server. In such cases the amended signed data object which includes the response is generated upon authenticating the signed data object and there is no need for a shared key between the authenticating service and the web service.

At block 835, which occurs if the response signed data object is not authenticated, the authentication server generated a rejected response and sends the rejected response to the web service server which sends it to the client computing device. The data of the rejected response includes the data of the signed data object, the data of the response of the webserver (E.g. an invoice) and an authentication field indicating that the message is rejected. The rejected response is signed by the shared key that is shared between the client and the authentication field. The rejected response is for warning the client about communication problems on the side of the web service server with the authentication service. The authentication server sends the rejected signed data object to the authentication service server to be sent to the client.

At block 840 the web service sends the message to the client.

FIG. 9A shows an exemplary block diagram of a first embodiment of a response signed data object, in accordance with some exemplary embodiments of the disclosed subject matter. The first embodiment of a response signed data object 900 includes the signed data object 402, the additional data 905 and the message-signature 907. The additional data include an invoice and a filed indicating that the invoice has to be appended to the message. The message signature 907 is generated by the shared key that is shared between the authentication service and the web service.

FIG. 9B shows an exemplary block diagram of a first embodiment of an amended signed data object, in accordance with some exemplary embodiments of the disclosed subject matter. The data of the amended signed data object includes the original data and the additional invoice. The message-signature 920 is generated by the shared key between the client and the authentication service.

FIG. 10A shows an exemplary block diagram of a second embodiment of a response signed data object, in accordance with some exemplary embodiments of the disclosed subject matter. The second embodiment of a response signed data object 930 includes the signed data object 402, the data to be amended 931 and the Message-signature) 935. The data to be amended includes an amended of the username and a field indicating that the username has to be amended.

FIG. 10B shows an exemplary block diagram of a second embodiment of an amended signed data object, in accordance with some exemplary embodiments of the disclosed subject matter; The data of the amended signed data object 945 includes the original data and such that the username is amended to “Dan”. The message-signature 940 is generated by the shared key between the client and the authentication service.

FIG. 11 shows a flowchart diagram of the scenario of adding a response with big data to the request of the user, in accordance with some exemplary embodiments of the disclosed subject matter.

According to some embodiment the response of the server to the user request may include big data. Such big data may include a large file, a video and etc. In such a case there is a need to avoid the generating of the signature from the big data.

Referring now to the drawing:

At block 1100, the web service server receives the validated signed data object from the authentication service as explained in block 245 of FIG. 2.

At block 1120, the web service server generates a checksum for the big data of the response. The checksum may be generated by methods such as SHA-1, MDS and CRC32.

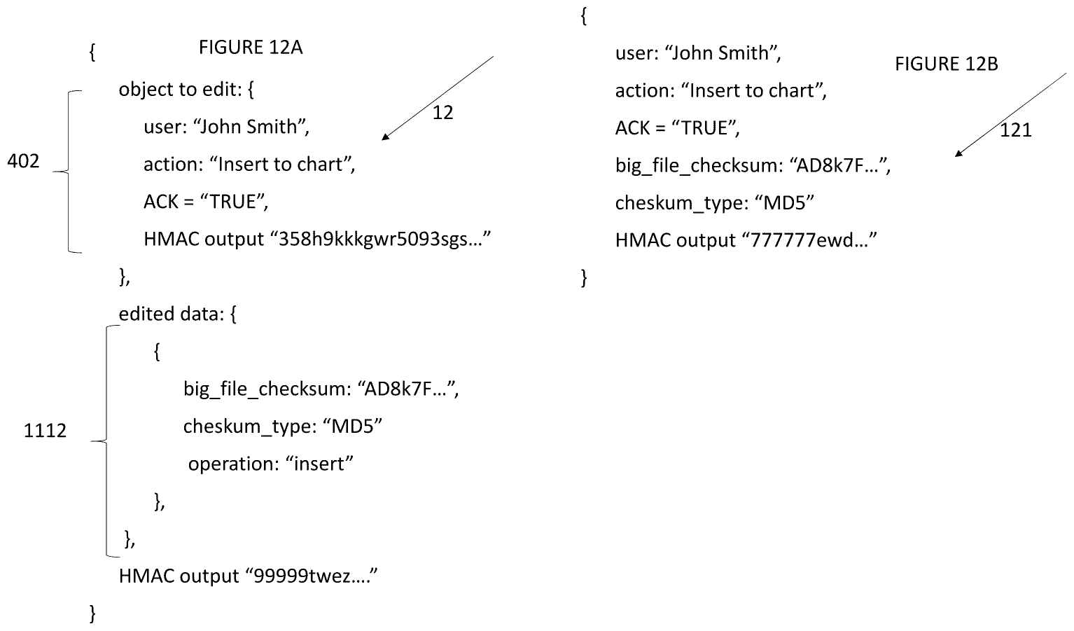

At block 1125. The web service generates a response signed data object by adding the checksum to the verified signed data object. An example of such response data object is depicted in FIG. 12. The web service server signed the response with a shared key that is shared between the web service server and the authentication service server. The web service server sends the response to the authentication service.

At block 1130 the authentication service authenticates the response signed data object. The authentication is performed with the shared key that is shared between the web service server and the authentication service server.

At block 1132, which occurs if the response signed data object is not authenticated by the authentication server, the authentication server generated a rejected response and sends the rejected response to the web service server which sends it to the client computing device.

Blocks 1135, 1140 and 1145 occur if the response signed data object is authenticated.

At block 1135, the authentication service generates an amended signed data object. The data of the amended signed data object includes the data of the signed data object and the checksum.

The authentication server generates a signature for the amended signed data object with the shared key that is shared between the client and the authentication server. The authentication server sends the amended signed data object to the website service server to be sent to the client.

At block 1140 web site server adds the big data file to the amended signed data object and sends to client.

At block 1145 the client verifies the signature of the amended signed data object and the checksum of the big file. The checksum of the big file is verified by regenerating the checksum from the big file of the received message and by comparing it to the checksum of the amended signed data object. If the response is authenticated the client receives the response otherwise the client terminates the session or initiates a retry.

FIG. 12A shows an exemplary response signed data object with big data, in accordance with some exemplary embodiments of the disclosed subject matter. Response signed data object with big data 12 includes the sighed data object 402, and the edited data 1112. The edited data includes the checksum of the file.

FIG. 12B shows an exemplary response signed data object with big data, in accordance with some exemplary embodiments of the disclosed subject matter. The amended signed data object with big data 121 includes the sighed data object and the checksum of the big. The message signature is generated from the data of the signed data object and from the checksum.

FIG. 13 shows a block diagram of an exemplary static web page, in accordance with some exemplary embodiments of the disclosed subject matter.

According to some embodiments the access to the shared key is via a static web page of the authentication service. The static web page includes functions for storing the shared key in the local storage of the client and for utilizing the shared key for validating and signing the signed data object.

According to some embodiments the static web page is divided into two separated portions for securing the shared key. The first portion includes the functions that success the shared key such as functions for storing the shared key and for generating and for signing the signed data object with the shared key. The second portion is a wrapper that used for calling the functions of the first portion, such that only the functions of the first portions access the shared key. The client computing device and the web service utilize the wrapper functions for operating the function of the first portion.

The static web page 10215 includes a first portion 102151 and a second portion 102152.

The first portion 102151 includes validation function 10211, string generation function 10213 and a function for generating a signed data object 10218. The validation function 10211 is configured for validating the signed data object. The validating is by generating a verification message-signature with the shared key 10216 and by comparing the verification message-signature with the message-signature of the verified message.

The string generation function 10213 is configured for generating a string. The string includes a URL (Uniform Resource Locator) to the static web page 1025 followed by a hash symbol “#” and followed by the shared key 10216. Example of such strings are depicted in FIGS. 3A and 3B.

The function for generating a signed data object 10218 is configured for generating a message-signature and for signing the message with the shared key 10216. In some embodiments the signature is the output of HMAC encryption.

The second portion 102151 includes wrapper functions that activate the functions of the first portion of the static web page 10215. The client authentication module 1031 and the web service 103 call the wrapper functions and do not have access to the first portion of the static web page for allowing only the authentication service for accessing the shared key.

The wrapper functions are: a wrapper to validation function 102111, wrapper to string generation function 102131 and a wrapper for a function for generating a signed data object 102181.

The wrapper to validation function 102111 operates the validation function 10211.

The wrapper to the string generation function 102131 operates the string generation function 10213 and the wrapper for a function for generating a signed data object 102181 operates the function for generating a signed data object 10218.

The wrapper functions do not access the shared key.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should be noted that, in some alternative implementations, the functions noted in the block of a figure may occur out of the order noted in the figures. For example, two blocks shown in succession may, in fact, be executed substantially concurrently, or the blocks may sometimes be executed in the reverse order, depending upon the functionality involved.

What is claimed is:

1. A computer-implemented method, comprising:
at a client computing device:
A. starting a communication session between said client computing device and a server of a web service;
B. receiving a shared key from an authenticating service via a designated channel;
C. generating a signed data object; said signed data object comprising data and a message-signature; said message-signature being generated by encrypting said data with said shared key;
D. transmitting said signed data object to said server of said web service and from said server of said web service to said authentication service; or
transmitting said signed data object to said authentication service;
at said authentication service:
E. receiving said signed data object;
F. validating said signed data object with said shared key;
G. if said signed data object being validated then:
i. generating a validated signed data object; wherein data of said validated signed data object comprises said data, an authentication filed indicating a success of said validating;
ii. transmitting said validated signed data object to said server of said web service and form said server of said web service to said client computing device; or transmitting said validated signed data object to said client computing device;
H. if said signed data object not being validated then:
i. generating a rejected signed data object; said data of said rejected signed data object comprises said data, an authentication filed indicating a failure of said validating and a second message-signature; said second message-signature being generated by encrypting said data and said authentication filed with said shared key;
ii. transmitting said rejected signed data object to said server of said web service and further, at said server of said web service, transmitting said signed data object to said client computing device; or transmitting said signed data object to said client computing device; and
at said client computing device:
I. If receiving a validated sign data object, then: validating said validated signed data object and continuing said session data if said validated signed data object being validated; otherwise terminating said session or initiating a retrying of said session; or
J. if receiving a rejected signed data object terminating said session or initiating a retrying of said session.

2. The method of claim 1 wherein said data of said signed data object comprises an action.

3. The method of claim 2 further comprising: if said signed data object being validated then at said server of said web service performing said action.

4. The method of claim 1, further compromising: at said server of said web service in response to receiving said validated signed data object, generating a response signed data object; said data of said response data object comprises said validated signed data object and additional-data or an instruction for amending said data of said validated signed data object; signing said response signed data object with a second shared key; said second shared key being shared between said web service server and said authentication server; transmitting said response signed data object to said authentication service server and at said authentication service server generation an amended signed data object from said response signed data object and sending said amended signed data object to said client computing device.

5. The method of claim 3, wherein said amended signed data object comprises said data of said validated signed data object and additional-data or an amendment of said data of said signed data object in accordance with said instruction.

6. The method of claim 1 wherein said designated channel being a mailbox.

7. The method of claim 3 wherein said additional data comprises big data, said response signed data object comprises a said signed data object and a checksum of said big data, said message signature of said response data object being generated by encrypting said signed data object and said checksum; wherein said amended signed data object comprises said signed data object and said checksum of said big data; said message signature of said response data object being generated by encrypting said signed data object and said checksum.

8. A system, the system comprises:
a web site service.com 1021 being installed on an authentication server; said web site service.com 1021 comprises a validation function 10211, a string generation function 10213, a key generation function 10212, a communication unit 10214, a static web page 1025 and a function for generating a signed data object 10218; said key generation function 10212 is configured for generating a shared key; said static web page 10215 includes a function for storing said shared key in the in a client browser's persistent cache; said function for generating a signed data object 10218 is configured for generating a Message-signature with said shared key and for signing a data object with said Message-signature; said validation function 10211 is configured for validating said signed data object with said shared key; said string generation function 10213 is configured for generating a string, said string comprises a URL (Uniform Resource Locator) to said static web page 1025 and a shared key; said string being sent to a client computing device via said communication unit; said communication unit 10214 is configured for transmitting the signed data object to said web site service.com 1021 for being sent to the client computing device; and for transmitting via email said shared key to said client computing device;
a client authentication module, said client authentication module comprises said validation function 10211, a client communication unit 10314, said function for generating a signed data object 10218; said client communication unit 10314 is configured for transmitting the signed data object to said web service for performing an action and for being sent to said authentication service; said client authentication module is further configured for receiving the shared key 10216 from the mailbox from the client.

9. The system of claim 8, wherein said web site service.com further comprising an allow origin function 10217.

10. The method of claim 4, wherein said static web page is separated into two portions; wherein a first portion of said static web page includes a function for accessing said shared key and wherein a second portion of said static web page includes a wrapper function said wrapper function is configured for activating said function for accessing said shared key, wherein said wrapper function is further configured for being used by said client authentication module and by a web server of said web site service.com.

11. The method of claim 8, wherein said function being a validation function 10211.

12. The method of claim 8, wherein said function being a string generation function 10213.

13. The method of claim 8, wherein said function being said function for generating a signed data object.

14. A non-transitory computer-readable medium comprising instructions which when executed by at least one processor causes the processor to perform the method according to claim 1.
